(19) United States
(12) Patent Application Publication
(10) Pub. No.: US 2014/0188866 A1
(43) Pub. Date: Jul. 3, 2014

(54) RECOMMENDATION ENGINE BASED ON CONDITIONED PROFILES

(71) Applicant: MICROSOFT CORPORATION, Redmond, WA (US)

(72) Inventors: Qiang Wu, Sammamish, WA (US); Raghava Viswa Mani Kiran Peddinti, Bellevue, WA (US); Novia Rosalinda Wijaya, Seattle, WA (US); Wanglong Yu, Redmond, WA (US); Donglin Xia, Redmond, WA (US); Jiayuan Huang, Sammamish, WA (US); Yi Mao, Redmond, WA (US); Dimitrios Lymberopoulos, Redmond, WA (US)

(73) Assignee: MICROSOFT CORPORATION, Redmond, WA (US)

(21) Appl. No.: 13/731,581

(22) Filed: Dec. 31, 2012

(51) Int. Cl. G06F 17/30

(52) U.S. Cl. CPC G06F 17/30867
USPC 707/732

(57) ABSTRACT

A conditional recommendation system and methods are presented. The conditional recommendation engine (embodied as a system, a method, or computer-readable media) provides recommendations of entities to a computer user based on a conditioned user profile for the computer user. The conditioned user profile identifies user preferences in regard to dynamic, changeable conditional factors. These factors may include the time of day that a request was made, the day of week, the month of the year, the season, whether it is a holiday and which holiday, and the like.

### BACKGROUND

Most online search services (also referred to as search engines) have a generally established pattern of responding to a search query with search results. An extension of this general pattern is to make the search results more relevant to the computer user that submits the query. To do this, a search engine will typically build and/or maintain a profile regarding a particular computer user. Thus, when the search service receives a search query from a computer user for which it has a corresponding profile, the search engine tailors the presentation of search results according to the user's profile.

In addition to search services, there are many applications and/or apps that provide a computer user (or mobile device user) with recommendations, and these apps will often respond with recommendations that are personalized to the user based on the user's profile as well as a reputation (or score) associated with an entity. For example, a user may operate an app on the user's mobile device that makes recommendations regarding restaurants. The app will return recommendations to the user based on various user preferences (types of food, etc.) and also according to reputations (or scores) associated with the various restaurants.

Both search engines and recommendation engines also maintain a profile regarding entities. When satisfying a search query or a recommendation request, in addition to examining user profiles, these services will also examine the profiles of the entities that might satisfy the request. Clearly, for a recommendation engine (or a search engine) it would be important to recommend and entity that provides high quality to the computer user. For these services, the entity profiles are derived from many factors, including popularity of the entity, user feedback, check-in data, reviews, and the like.

User profiles are often based on probability density functions (PDFs) such that given a particular scenario, the user is more likely to choose one outcome over another. Further still, a user's PDF will often be expressed in terms of percentages, e.g., given the scenario, the user will choose Option A 90% of the time. Entity reputations are based on visits, user-supplied rankings, and the like. However, while search services, applicants, apps—e.g., recommendation services—utilize user and entity profiles in responding to a computer user with tailored, relevant search results, the user and entity profiles that are relied upon are largely static and ignore the fact that during certain periods of the day, on certain days of the week, given the current location of a user, or a combination of these or other dynamic factors, user preferences and entity reputations will vary.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

A recommendation engine based on conditioned profiles and methods for providing recommendations based on the conditioned profiles are presented. The recommendation engine (embodied as a system, a method, or computer-readable media) provides recommendations of entities to a computer user based on a conditioned user profile for the computer user as well and entities. The conditioned user profile identifies user preferences in regard to dynamic, changeable conditional factors. These factors may include the time of day that a request was made, the day of week, the month of the year, the season, whether it is a holiday and which holiday, and the like.

According to aspects of an alternative embodiment, a recommendation engine, computer readable media, and methods for providing recommendations based on conditioned profiles of both user and entities are presented. The recommendation engine (embodied as a system, a method, or computer-readable media) provides recommendations of entities to a computer user based on both a conditioned user profile for the computer user and a conditioned user profile for the recommended entities. The conditioned profiles are made in regard to dynamic, changeable conditional factors. These factors may include the time of day that a request was made, a geographic location of the user and/or entity, the day of week, the month of the year, the season, whether it is a holiday and which holiday, and the like.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a diagram illustrating an exemplary networked environment suitable for implementing aspects of the disclosed subject matter;

FIGS. 2A-2C are pictorial diagrams illustrating a mobile device providing recommended entities to the device user according to aspects of the disclosed subject matter;

FIG. 3 is a flow diagram illustrating an exemplary routine suitable for providing recommended entities for a computer user based on the user's profile conditioned upon one or more conditional factors according to aspects of the disclosed subject matter;

FIG. 4 is a flow diagram illustrating an exemplary routine for responding to a search query from a computer user with recommended entities;

FIG. 5 is a block diagram illustrating at least some of the data/information from which user profiles can be updated according to conditional factors as well as conditioning information regarding entities;

FIG. 6 is a block diagram illustrating an exemplary search engine 600 configured to respond to search queries from computer users with search results pages that include recommendations made according to conditional factors; and

FIG. 7 is a block diagram illustrating an exemplary recommendation engine in accordance with aspects of the disclosed subject matter.

### DETAILED DESCRIPTION

For purposed of clarity, the use of the term “exemplary” in this document should be interpreted as serving as an illustration or example of something, and it should not be interpreted as an ideal and/or leading illustration of that thing. An “entity” refers to any of a person or group of people, an object, an organization, an establishment, a concept, and the like. As will be seen throughout the remainder of this document, an entity is the subject matter of a recommendation to a computer user. A conditioned user profile is a user profile that has been updated to varying preferences with regard to conditional factors. Conditional factors are dynamic conditions or factors that may affect the preferences (and be reflected in a user profile) of a computer user depending on the current “value” of the condition. Conditional factors may include (by way of illustration and not limitation) the time of day, the day of the week, the month of the year, holidays, seasons, geographic locations, and the like.

A recommendation engine (as will be discussed below) identifies one or more entities relevant to a computer user (typically based on a conditioned user profile) and recommends the entities to the user. An “application” (or software program) is a set of one or more executable modules that cooperatively carry out a set of tasks on a computing device. As will be discussed below, aspects of the disclosed subject matter may be implemented in one or more software applications. An “app” is a specific form of application typically designed to operate on a mobile device (e.g., tablet, smart phone, etc.) and is typically designed to carry out a specific task.

In contrast to recommendation engines that make recommendations to users based on generalized user profiles, aspects of the disclosed subject matter are directed to making recommendations to computer users based on conditional user profile information. More particularly, in addition to relying on a single user profile in all instances in making entity recommendations, a conditional recommendation engine (i.e., a recommendation engine that makes recommendations based on conditioned user and/or entity profiles) determines one or more conditional factors and makes recommendations according to a user profile conditioned according to the one or more factors as well as entity profiles including those entity profiles that are similarly conditioned according to conditional factors.

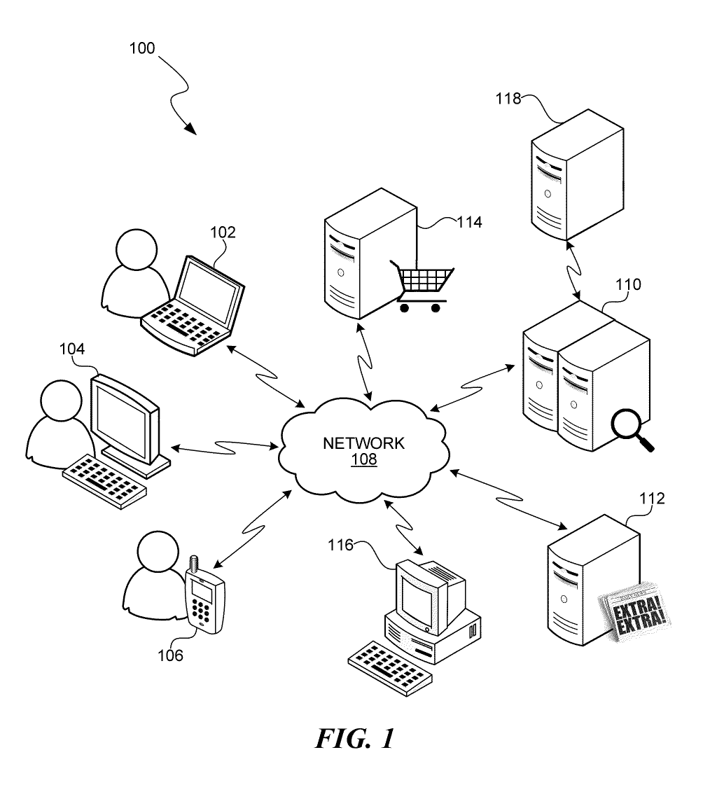

Turning now to FIG. 1, this figure shows an illustrative diagram of an exemplary networked environment 100 suitable for implementing aspects of the disclosed subject matter. The illustrative environment 100 includes one or more user computers, such as user computers 102-106, connected to a network 108, such as the Internet, a wide area network or WAN, and the like. Also connected to the network 108 is a search engine 110 configured to provide search results in response to search queries received from computer users. As mentioned, search results provided to a user in response to a search query may include one or more recommended entities as provided by a conditional recommendation engine 118.

Those skilled in the art will appreciate that, generally speaking, a search engine 110 corresponds to an online service hosted on one or more computers, or computing systems, located and/or distributed throughout the network 108. The search engine 110 receives and responds to search queries submitted over the network 108 from various computer users, such as the computer users that may be connected to user computers 102-106. In particular, responsive to receiving a search query from a computer user, the search engine 110 obtains search results information related and/or relevant to the received search query (as defined by the terms of search query.) The search results information includes search results, i.e., references (typically in the form of hyperlinks) to relevant and/or related entities (including recommended entities recommended by a conditional recommendation engine 118) available at various network locations, such entity sites 112-116, located throughout the network 108. Of course, as those skilled in the art will appreciate, not all recommended entities will have a corresponding entity site on the network 108. Indeed, some recommended entities may correspond to people, physical locations and the like and may not have an online presence. Thus, a recommendation to those entities will simply be informational (e.g., how to contact the entity.)

As illustrated in FIG. 1, the conditional recommendation engine 118 is shown as operating in conjunction with the search engine 110. According to at least one embodiment (not shown), the conditional recommendation engine 118 is a component of the search engine 110. Alternatively, the conditional recommendation engine 118 may be implemented to operate independently of a search engine 110 and provide entity recommendations (based on conditioned user profiles) to one or more apps and/or applications implemented on any number of computing devices, such as user computing devices 102-106.

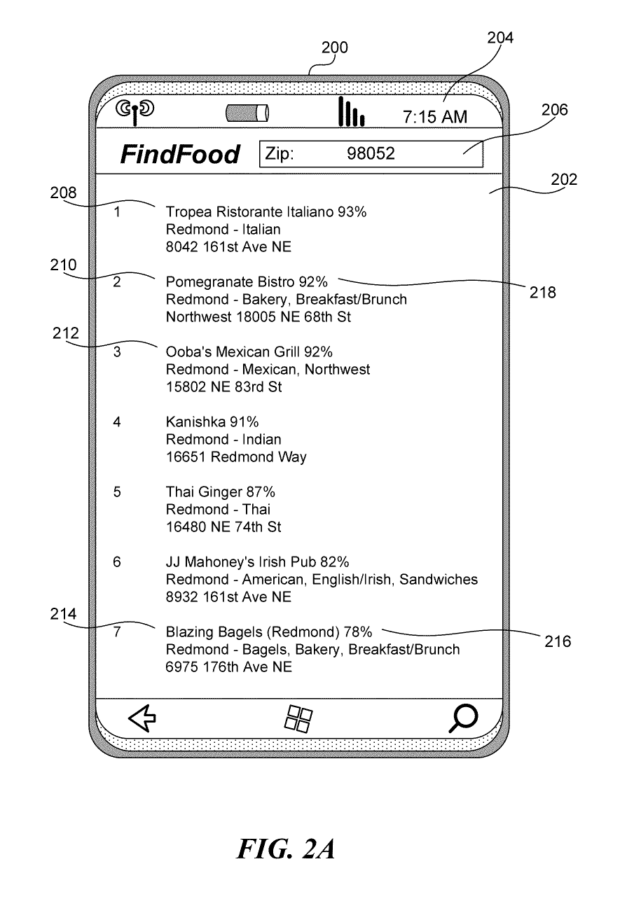

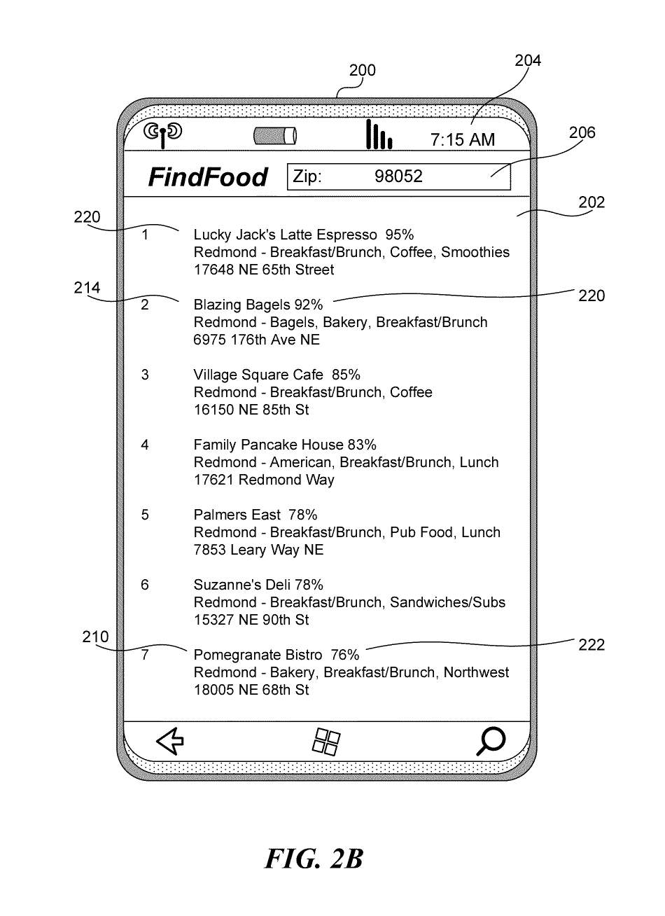

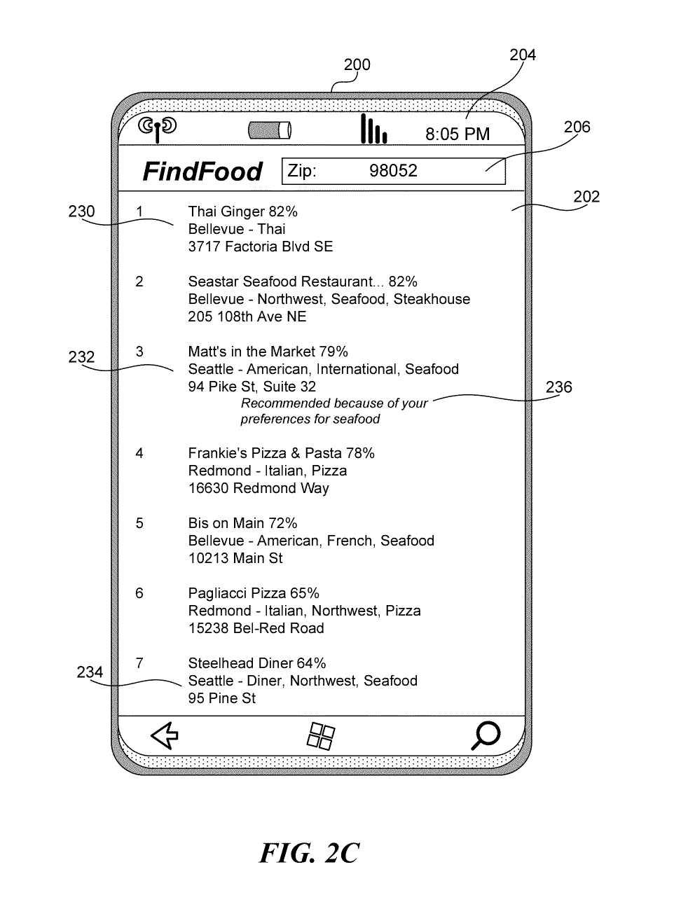

To better understand how entity recommendations can be conditioned according to one or more conditional factors, reference now is made to FIGS. 2A-2C. Generally speaking, FIGS. 2A-2C show pictorial diagrams illustrating a mobile computing device providing recommended entities to the device user. Indeed, turning to FIG. 2A, the illustrated mobile device 200 includes a display area 202 in which an exemplary app executing on the mobile device is displaying recommendations of restaurants, including recommendations 208-214. For this example, the restaurant recommendations are based on an explicit location as indicated by box 206. The recommendations include corresponding scores, such as recommendation scores 216-218, typically indicating the popularity of the recommended restaurant, the likelihood that the device user will feel favorable to the restaurant, or a combination. In this example, the higher the recommendation scores the better the recommendation to the user. However, the recommendations shown in FIG. 2A are typical of recommendations provided to a user based on a single user profile for that user, and that fails to take into account conditional factors. For example, while recommendation 208 may be a terrific choice for dinner for the user, it may not be a good choice early in the morning, as indicated on the mobile device at location 204.

In contrast to typical recommended results, FIG. 2B shows the mobile device 200 providing restaurant recommendations to a user based on a user profile conditioned according to one or more conditional factors. Indeed, the recommendations in the display area 202 are based on a conditioned user profile that considers both the time of day (as shown in location 204) as well as current location (as indicated by box 206.) As can be seen, the recommendations, including recommendations 220, 214, and 210, are more appropriate given the current time of day. Moreover, the recommendation scores also reflect conditional factors. For example, recommendation 214 was listed near the bottom of the display area 202 in FIG. 2A with a recommendation score of “78” (216), while in FIG. 2B it is listed much higher with a commensurately higher recommendation score of “92” (220). Similarly, recommendation 210 drops from high in the recommendations of FIG. 2A to the bottom in FIG. 2B, due to the user profile conditioned according to current conditional factors.

As a further illustration of how conditional factors may play a role in determining recommendations, FIG. 2C shows the recommendations based on an evening time (as indicated by location 204. As can be seen, the recommendations (including recommendations 230-234) are changed to reflect the user's profile conditioned upon the current time and location. However, the recommendations include recommendations 232 and 234 that are not generally considered local (i.e., Seattle) to the currently selected area (as indicated by box 206.) For this example this illustrates the fact that the user is willing to travel farther during the evening hours for restaurants that he/she prefers.

According to additional aspects of the disclosed subject matter, in addition to providing a recommendation to the user based on the user's conditioned profile (as well as an entity's conditioned profile), the recommendation engine may also include or provide annotations describing “why” an entity was recommended. For example, recommendation 232 includes an annotation 236 suggesting that at least one reason that the recommendation was made to the user is because of a preference to seafood. Of course, there may be many reasons that a particular recommendation, such as recommendations 232 or 234, are made. While all of the rationale may be provided with a given recommendation, in at least one configuration the rationale having the greatest impact in recommending the entity is provided in the annotation. Similarly, a determination to display annotations in all cases, in select cases, at user request may be made according to implementation decisions.

It should be appreciated that while much of the discussion about the recommendation engine based on conditioned user and/or entity profiles is made with regard to restaurants, this is for simplicity in presentation only and should not be viewed as being the only type of entity that may be recommended. Recommended entities may correspond to (by way of illustration) current deals offered by vendors, local attractions, transit systems, and the like. Indeed, there are numerous types and categories of entities that may be recommended by a recommendation engine configured according to aspects of the disclosed subject matter. Additionally, while much of the application is described in regard to conditioning according to time (time of day), current geographic location is another common conditional factor with regard to recommending entities.

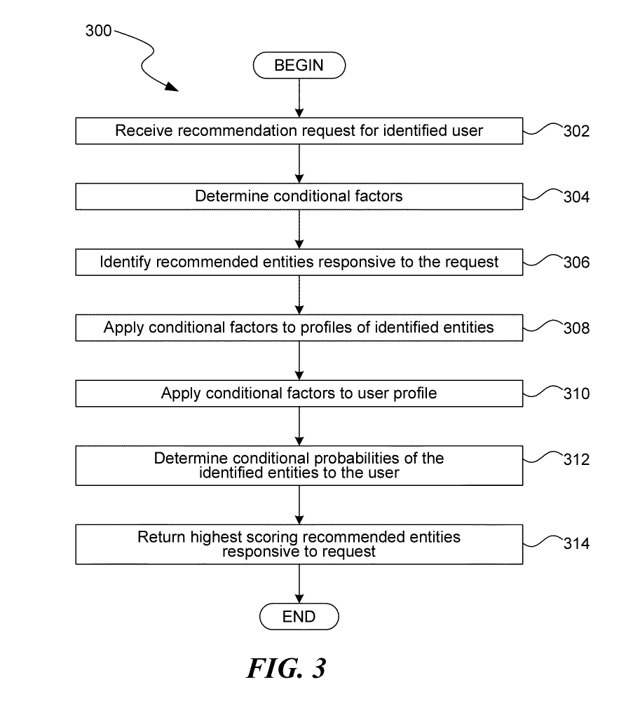

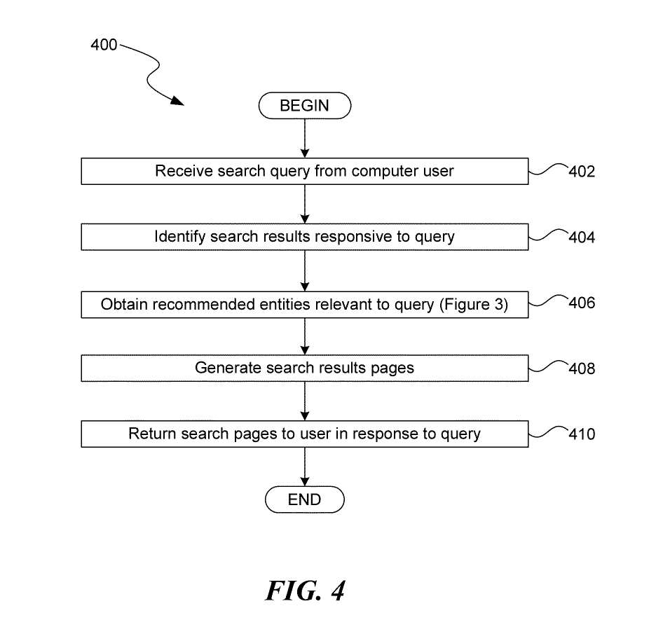

Turning now to FIG. 3, this figures is a flow diagram illustrating an exemplary routine 300 suitable for providing recommended entities for a computer user based on the user's profile and entity profiles conditioned upon one or more conditional factors according to aspects of the disclosed subject matter. Beginning at block 302 a recommendation request for an identified user is received.

At block 304, one or more conditional factors are determined and/or identified. As previously suggested, these conditional factors are factors that may have a bearing on the relevancy of an entity to the user as well as the entity itself. The conditional factors may be considered alone or in various combinations. These condition factors may include, by way of illustration and not limitation: the time of day; the day of week; holidays; seasons of the year; geographic location; and the like. Thus determining the one or more conditional factors may include (by way of illustration) determining the time of day that the request is made as well as the day of week of the request.

At block 306, a subset of entities from a plurality of entities (which are typically stored in an entity store) is identified. According to aspects of the disclosed subject matter, the entities of this subset comprise those entities that generally related to, or considered responsive to, the subject matter of the recommendation request. These are “generally related to” or “generally responsive to” the recommendation request because a more robust evaluation of the entities with regard to the user profile, especially in light of the determined conditional factors has not been made. Hence, at block 308, the determined conditional factors (of step 304) are applied to the entity profiles of the identified subset of entities such that proper evaluation of conditional probabilities may be applied (i.e., determining the likelihood that the recommended entity is a good match for the user.)

At block 310 the various conditional factors are applied to the user profile for the identified user. At block 312 the conditioned profiles of the identified entities and the conditional user profile are evaluated according to one or more heuristics and/or conditional probability functions to determine the probability or likelihood that a given entity is a good match as a recommendation to the user. The various likelihoods of entities indicating that the user will be favorably inclined to a particular entity can then be viewed as a type of score for the given entity, and the identified subset of entities. Thus, at block 314, the identified subset of recommended entities is ordered and a smaller subset comprising the highest scoring recommended entities is returned in response to the request. Thereafter, routine 300 ends.

While routine 300 is made in regard to receiving a recommendation request, in an alternative embodiment the various aspects of a conditional user profile may be determined asynchronously from any request and stored for subsequent retrieval and usage. Thus, in an alternative embodiment (not shown), a given user profile is conditioned and stored in a user profile store. Similarly, entity profiles are conditioned and stored in an entity profile store. Moreover, as additional information is obtained that may affect the user profile or an entity profile, that profile is updated.

As suggested above, in addition to operating as a recommendation engine to a variety of apps and/or applications as well as online services, aspects of the disclosed subject matter may be embodied within a search engine and manifest as part of the search results. For example, a computer user visiting a new area may wish to find a restaurant for dining. By entering a search query, the computer user would be presented with substantial information including recommended restaurants from the recommendation engine. To this end, FIG. 4 is a flow diagram illustrating an exemplary routine 400 for responding to a search query from a computer user with recommended entities. Beginning at block 402, the search engine 110 receives a search query from a computer user. At block 404, search results responsive to the search query are identified. These search results may be identified according to a user profile corresponding to the user that the search engine maintains (or has access to) in a user profile store. According to aspects of the disclosed subject matter, the user profile is conditioned according to various conditioning factors and the search results responsive to the search query are retrieved and ordered according to the conditioned user profile.

At block 406, in addition to obtaining search results responsive to the search query, the search engine 110 obtains recommended entities that are also relevant to the query, as described in regard to FIG. 3. According to aspects of the disclosed subject matter, these recommended entities are identified by a recommendation engine (either as part of or in cooperation with the search engine 110) and based on the conditioned user profile. At block 408, the search engine generates one or more search results pages according to the obtained search results and the recommended entities. At block 410, at least one search results page is returned to the computer user in response to the search query. Thereafter, the routine 400 terminates.

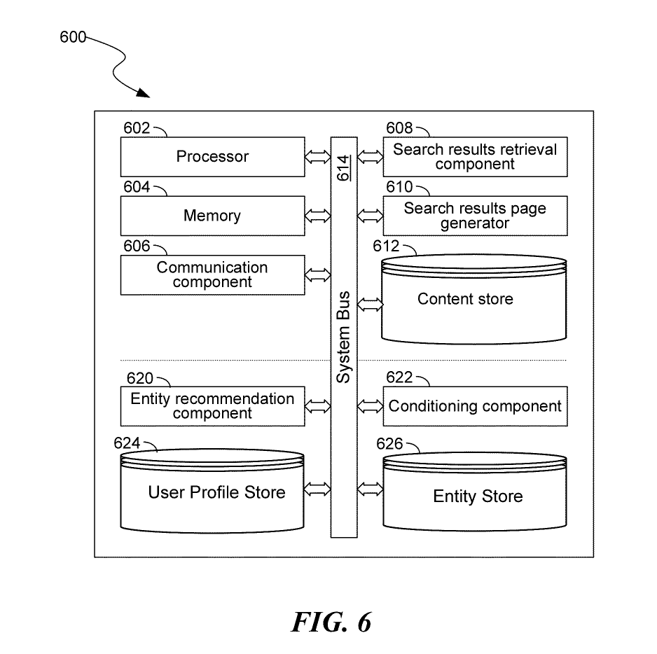

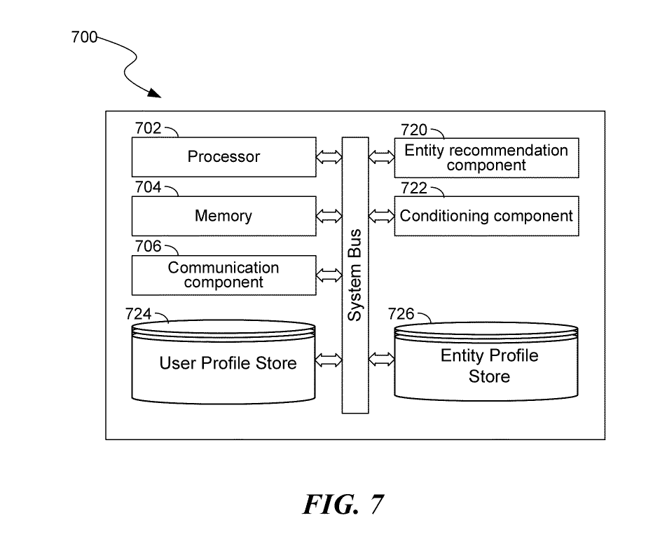

Regarding routines 300 and 400, it should be appreciated that while these are expressed with discrete steps in providing recommended entities, these steps should be viewed as being logical in nature and may or may not correspond to any actual and/or discrete steps. Nor should the order that these steps are presented in the various, illustrative routines be construed as the only order in which the steps may be carried out. While these steps include various novel features of the disclosed subject matter, other steps (not listed) may also be carried out in the execution of routines 300 and 400. Further, those skilled in the art will appreciate that logical steps may be combined together or be comprised of multiple steps. Steps of routines 300 and 400 may be carried out in parallel or in series. Often, but not exclusively, the functionality of the various routines is embodied in software (e.g., applications, system services, libraries, and the like) that is executed on computer hardware such as the user computers 102-106 described above or the systems described below in regard to FIGS. 6 and 7.

Further, while the above-described novel aspects of the disclosed subject matter are expressed in routines, applications (also referred to as computer programs), and/or methods, these aspects may also be embodied in instructions stored in computer-readable media (also referred to as computer-readable storage media). As those skilled in the art will appreciate, computer-readable media can host computer-executable instructions for later retrieval and execution. When executed on a computing device, the computer-executable instructions stored on one or more computer-readable storage devices carry out various steps, methods and/or functionality, including those steps, methods, and routines described above. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

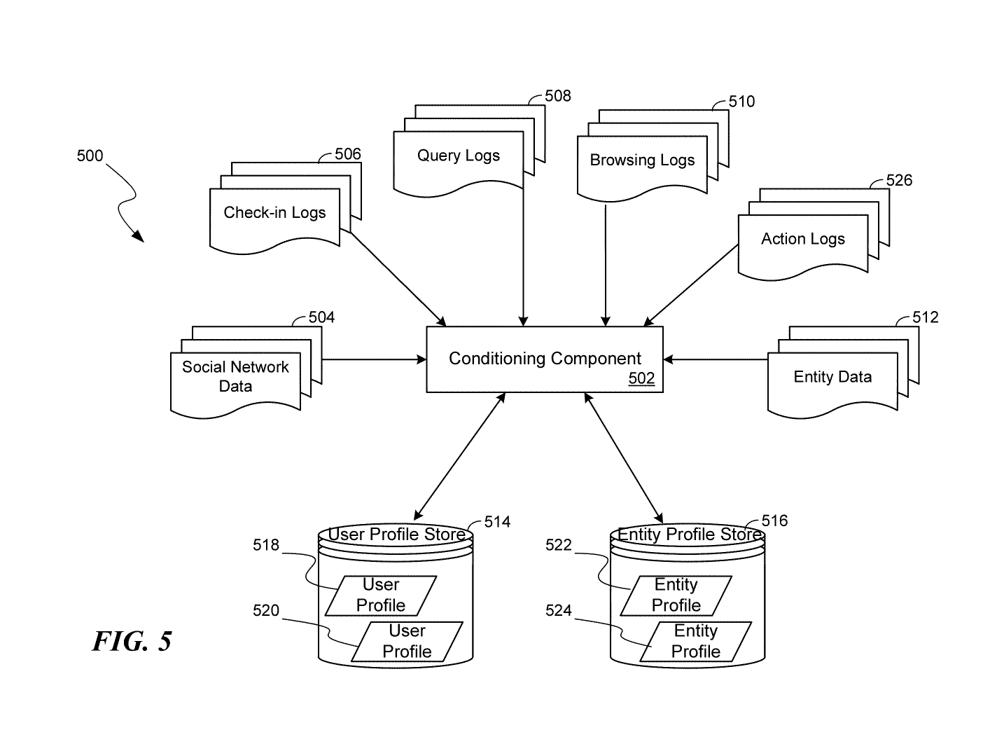

In regard to updating user and entity profiles according to conditional factors, this type of condition is determined according to variety of sources. FIG. 5 is a block diagram 500 illustrating at least some of the data/information from which user and/or entity profiles can be updated according to conditional factors. As suggested in the diagram 500, there are numerous sources of information that a conditioning component 502 accesses and digests in order to update or “condition” a user's profile according to conditional factors. Of course, there may be additional or fewer sources of data that are relied upon. Accordingly, while diagram 500 identifies various sources of data to use, the identified sources should be viewed as illustrative and not limiting upon the disclosed subject matter. According to various embodiments of the disclosed subject matter, the conditioning component 502 may be implemented as an executable module on a computing device, such as an executable module within a suitably configured search engine or a recommendation platform. Moreover, the conditioning component 502 may be implemented as a set of cooperative modules (executing on a single computing system or a plurality of computing systems) for processing the various data sources as described below. Further still, a plurality of conditioning components (not shown) may be deployed where each individual component (or set of components) is responsible for processing and analyzing data of a single type, such as check-in data 506.

Generally speaking, the conditioning component 502 accesses user profiles, such as user profiles 518 and 520, from a user profile store 514, mines and analyzes information about the user from the various sources according to the various conditional factors, and updates the user profile with the conditional information. Similarly, the conditioning component 502 can “condition” entity profiles (such as entity profiles 522 and 524) by accessing the profiles in an entity profile store 516, mining and analyzing data relevant to the entity from various sources in regard to the conditional factors being considered, and updating the entity profiles in the entity store.

One of the sources of data that the conditioning component 502 may utilize in conditioning/updating a user profile is check-in logs 506. Check-in logs 506 can be made explicitly by computer users (i.e., through an explicit action to indicate that the computer user is or was at a particular location or venue) or, alternatively, through automatic and/or implicit actions. Another source of data that may be used by the conditioning component 502 is query logs. The conditioning component 502 may also access query logs 508 from which the condition component identifies and analyzes queries corresponding to the particular user whose user profile is being updated in order to identify how the user profile should be updated.

In addition to check-in logs 506 and query logs 508, the conditioning component 502 may access browsing logs 510, i.e., a record of where a user navigates a browser on the network 108 as well as the browsing behavior at the various target sites. The browsing logs 510 may also include purchase histories though, in an alternative embodiment (not shown), purchase histories may be viewed as an independent data source. A computer user's social network data 504, comprising information such as preferences and likes of one or more groups of people with which the computer user is associated, is another source of information for the conditioning component to user in conditioning a user profile. Action logs 526 corresponding to actions and/or activities carried out by the computer user, such as phone numbers that are called, clicks and/or selections on a computing device, reservations that are made, apps and/or applications that are used by the computer user, and other similar data, may also be accessed by the condition component 502.

In addition to the generally user-specific data sources (e.g., 504-510), the conditioning component 502 also digests data sources/information regarding entities. As shown in diagram 500, the conditioning component accesses entity data 512 updates/conditions the various entity profiles (e.g., 522 and 524) in the entity profile store 516 to reflect the relevant information regarding the conditioning factors. Moreover, while data sources 504-510 are often viewed as particularly directed to individual users, such as check-in logs, query logs, browsing logs, and the like, this information may also contain relevant information regarding entities with corresponding entity profiles in the entity store 516. For example, the social network data 504 also frequently provides substantial information regarding entities. A computer user's social network may “like” a particular entity, and/or post or broadcast information the entity, all of which may have a bearing on the entity's conditional profile. In addition, this information typically includes date, interests of the particular social group (or groups), time and geographic location information that may be analyzed to condition the entity's profile as well as a user's profile. Thus, as this information is processed and analyzed with regard to a user (to update the user's conditioned profile), it may similarly be processed and analyzed with regard to entities and the corresponding conditional entity profiles (e.g., 522-524).

As mentioned above, the various sources illustrated diagram 500 are some examples of the various data sources that can and, perhaps, should be analyzed and processed to update/condition user and entity profiles. However, for any particular implementation of the disclosed subject matter, the conditioning component 502 may access any combination of the described data sources as well as other data sources that may be accessed. Indeed, one of the inherent advantages of the disclosed subject matter is that a recommendation engine or platform may be easily scaled to process any number of data sources (and, correspondingly, update user and/or entity profiles) as they become available.

Turning now to FIG. 6, FIG. 6 is a block diagram illustrating an exemplary search engine 600 configured to respond to search queries from computer users with search results pages that include recommendations made according to conditional factors. The search engine 600 includes a processor (or processing unit) 602 and a memory 604 interconnected by way of a system bus 614. As those skilled in the art will appreciate, the processor 602 executes instructions retrieved from the memory 604 in carrying out various functions, particularly in responding to search queries with results including recommended entities. The processor 602 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like. The memory 604 may be comprised of both volatile memory (e.g., random access memory or RAM) and non-volatile memory (e.g., ROM, EPROM, EEPROM, etc.)

The system bus 614 provides an interface for search engine's components to inter-communicate. The system bus 614 can be of any of several types of bus structures that can interconnect the various components (including both internal and external components). The illustrative search engine 600 further includes a network communication component 606 for interconnecting the search engine with other computers (such as user computers 102-106 and other networking sites 114-116) and devices on a computer network 108. The network communication component 606 may be configured to communicate with an external network, such as network 108, via a wired connection, a wireless connection, or both.

The search results retrieval component 608 obtains search results responsive to the search engine 600 receiving a search query from a computer user. The search results page generator 610 generates one or more search results pages that may be presented to the computer user in response to the received search query. The search results page generator 610 generates the search results pages based on the search results retrieved by the search results retrieval component 608 and, according to aspects of the disclosed subject matter, also on recommended entities from the entity recommendation component 620. The entity recommendation component 620 obtains a user profile (such as user profile 518 or 520 of FIG. 5) corresponding to the computer user from a user profile store 624 and uses the user profile to identify recommended entities based on one or more conditional factors. According to at least one embodiment, if the user profile is not a conditioned user profile, as part of recommending entities the search engine 600, via the conditioning component 622, updates the user profile and stores the updated user profile in the user profile store 624.

As already suggested, the user profile store 624 stores a plurality of user profiles for a corresponding plurality of computer users. The entity profile store includes a plurality of entity profiles that provide information regarding a plurality of entities, and may include information related to the various conditional factors described above.

In addition to, or as an alternative to, a search engine 600 including a recommendation feature, a recommendation engine may operate independently or in cooperation with a search engine, online services, applications, apps, and the like. To this end, FIG. 7 is a block diagram illustrating an exemplary recommendation engine 700. The recommendation engine includes a processor 702 and a memory 704 interconnected by way of a system bus 714. As with the search engine 600 of FIG. 6, the processor 702 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like. Moreover, the memory 704 may be comprised of both volatile memory (e.g., random access memory or RAM) and non-volatile memory (e.g., ROM, EPROM, EEPROM, etc.) Similarly, the recommendation engine includes a communication component 706 for interconnecting the recommendation engine with other services, applications, and/or apps over the computer network 108. The network communication component 706 may be configured to communicate with an external network, such as network 108, via a wired connection, a wireless connection, or both.

The entity recommendation component 720 obtains a user profile (such as user profile 518 or 520 of FIG. 5) corresponding to the computer user from a user profile store 724 and uses the user profile to identify recommended entities based on one or more conditional factors. As described above, in at least one embodiment if the user profile is not a conditioned user profile the conditioning component 722 updates the user profile and stores the updated user profile in the user profile store 724. The user profile store 724 stores a plurality of user profiles for a corresponding plurality of computer users. The entity profile store 726 includes a plurality of entity profiles (such as entity profiles 522 and 524 shown in FIG. 5) that provide information regarding a plurality of entities, and may include information related to the various conditional factors described above.

It should be appreciated, of course, that the various components described above in regard to the search engine 600 and/or the recommendation engine 700 should be viewed as logical components for carrying out the various described functions. As those skilled in the art appreciate, logical components (or subsystems) may or may not correspond directly in a one-to-one manner to actual components, including the components described above in regard to the search engine 600 of FIG. 6 or the recommendation engine 700 of FIG. 7. Moreover, in an actual embodiment, these components may be combined together or broke up across multiple actual components and/or implemented as cooperative processes on a computer network 108.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method executed on a computing device, comprising at least a processor and a memory, for responding to a request for recommended entities for a computer user, the method comprising:
identifying a plurality of entities from an entity store responsive the request for recommended entities for the computer user;
determining the current value of at least one conditional factor;
scoring the identified entities according to a user profile corresponding to the computer user, wherein the user profile is conditioned upon the current value of the at least one conditional factor; and
responding to the query with information identifying a subset of the plurality of entities, the subset comprising the highest scoring entities.

2. The computer-implemented method of claim 1 further comprising determining the current values of a plurality of conditional factors; and
wherein the user profile is conditioned upon the current values of the plurality of conditional factors.

3. The computer-implemented method of claim 1 further comprising obtaining the user profile corresponding to the computer user from a user profile store storing a plurality of user profiles.

4. The computer-implemented method of claim 3 further comprising determining that the user profile is not conditioned according to the at least one conditional factor;
updating the user profile to be conditioned according to the at least one conditional factor; and
storing the conditioned user profile corresponding to the computer user in the user profile store.

5. The computer-implemented method of claim 4, wherein the steps of determining that the user profile is not conditioned, updating the user profile, and storing the conditioned user profile are performed asynchronously to responding to the query for recommended entities for the computer user.

6. The computer-implemented method of claim 4, wherein updating the user profile to be conditioned according to the at least one conditional factor comprises analyzing a plurality of data sources corresponding to the computer user with regard to the at least one conditional factor and conditioning the user profile with regard to the at least one conditional factor based on the analysis.

7. The computer-implemented method of claim 4, wherein the plurality of data sources at two of check-in logs, query logs, browsing logs, and social network data.

8. The computer-implemented method of claim 1, wherein the at least one conditional factor comprises any one of the time-of-day, the day of week, a geographic location, the month of the year, a season, and a holiday.

9. The computer-implemented method of claim 1, wherein scoring the identified entities further comprises scoring the entities according to a user profile conditioned upon the current value of the at least one conditional factor and according to entity profiles conditioned upon the current value of the at least one conditional factor.

10. A computer-readable medium bearing computer-executable instructions which, when executed on a computing system comprising at least a processor executing instructions retrieved from the medium, carry out a method for responding to a query for recommended entities for a computer user, the method comprising:
identifying a plurality of entities from an entity store responsive the query for recommended entities for the computer user;
determining the current value of at least one conditional factor;
scoring the identified entities according to entity profiles corresponding to each of the identified entities and a user profile corresponding to the computer user, wherein the user profile is conditioned upon the current value of the at least one conditional factor, and wherein at least one entity profile is conditioned upon the current value of the at least one conditional factor; and
responding to the query with information identifying a subset of the plurality of entities, the subset comprising the highest scoring entities according to the user profile conditioned upon the current value of the at least one conditional factor.

11. The computer-readable medium of claim 10, wherein the method further comprises determining the current values of a plurality of conditional factors, and wherein the user profile and the at least one entity profile are conditioned upon the current values of the plurality of conditional factors.

12. The computer-readable medium of claim 10, wherein the method further comprises:
obtaining the user profile corresponding to the computer user from a user profile store storing a plurality of user profiles;
determining that the user profile is not conditioned according to the at least one conditional factor;
updating the user profile to be conditioned according to the at least one conditional factor; and
storing the conditioned user profile corresponding to the computer user in the user profile store.

13. The computer-readable medium of claim 12, wherein the steps of determining that the user profile is not conditioned, updating the user profile, and storing the conditioned user profile are performed asynchronously to responding to the query for recommended entities for the computer user.

14. The computer-readable medium of claim 13, wherein updating the user profile to be conditioned according to the at least one conditional factor comprises analyzing a plurality of data sources corresponding to the computer user with regard to the at least one conditional factor and conditioning the user profile with regard to the at least one conditional factor based on the analysis.

15. The computer-readable medium of claim 13, wherein the plurality of data sources at two of check-in logs, query logs, browsing logs, and social network data.

16. The computer-readable medium of claim 10, wherein the at least one conditional factor comprises any one of the time-of-day, the day of week, a geographic location, the month of the year, a season, and a holiday.

17. The computer-readable medium of claim 10, wherein scoring the identified entities further comprises scoring the entities according to a user profile conditioned upon the current value of the at least one conditional factor and according to entity profiles conditioned upon the current value of the at least one conditional factor.

18. A computer system for responding to a query for recommended entities for a computer user, the system comprising a processor and a memory, wherein the processor executes instructions stored in the memory as part of or in conjunction with additional components to respond to a request for entities, the additional components comprising:
a communication component configured to receive queries over a network regarding recommended entities and respond to the queries with recommended entities;
a user profile store storing a plurality of user profiles corresponding to a plurality of computer users; and
an entity recommendation component configure to:
obtain a user profile corresponding to a computer user for which recommended entities have been requested;
identify a plurality of entities from an entity profile store responsive the request for recommended entities for the computer user;
determine the current value of at least one conditional factor;
score the identified entities according to the user profile, wherein the user profile is conditioned upon the current value of the at least one conditional factor; and
respond to the request with information identifying a subset of the plurality of entities, the subset comprising the highest scoring entities according to the user profile conditioned upon the current value of the at least one conditional factor.

19. The computer system of claim 18, wherein the at least one conditional factor comprises any one of the time-of-day, the day of week, a geographic location, the month of the year, a season, and a holiday.

20. The computer system of claim 19, wherein the user profile is conditioned upon the current value of the at least one conditional factor; and
wherein the entity recommendation component is further configured to:
determine the current value of a plurality of conditional factors; and
score the identified entities according to the user profile conditioned upon the plurality of conditional factors.
